(19) United States
(12) Patent Application Publication
(10) Pub. No.: US 2022/0299146 A1
(43) Pub. Date: Sep. 22, 2022

(54) FLUID MONITOR ELBOW

(71) Applicant: Akron Brass Company, Wooster, OH (US)

(72) Inventor: Adam Uhler, Sterling, OH (US)

(73) Assignee: Akron Brass Company, Wooster, OH (US)

(21) Appl. No.: 17/699,871

(22) Filed: Mar. 21, 2022

Related U.S. Application Data
(60) Provisional application No. 63/163,440, filed on Mar. 19, 2021.

(51) Int. Cl. F16L 43/00; A62C 35/68

(52) U.S. Cl. CPC F16L 43/00; A62C 35/68

(57) ABSTRACT

One or more techniques and/or systems are disclosed for improving a fluid stream profile in the flow of fluid through a fire monitor system. An exemplary technique involves a flow elbow having a first rib, a second rid, and a gap between the first rib and the second rib. The gap can be configured to allow fluid to flow through the gap to reduce turbulence in the flow of fluid through the elbow.

### CROSS-REFERENCE TO RELATED APPLICATIONS

This application claims priority to U.S. Provisional Ser. No. 63/163,440, entitled FLUID MONITOR ELBOW, filed Mar. 19, 2021, all of which is incorporated herein by reference.

### BACKGROUND

Industrial fluid dispensing devices, often referred to as deluge guns or fire monitors, are used in the firefighting industry to dispense large quantities of water in a controlled stream. Fire monitors are coupled to a water source at a first end and direct a flow of water through the monitor and out the second end of the monitor. Flow nozzles can be attached to the monitor at the second end to better control the flow and stream of water.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to improve a fluid flow stream profile of fluid passing through a fluid monitor, and discharging from an outlet of a coupled nozzle. A centrally disposed rib comprising a first rib and a second rib, with a gap therebetween, can improve an even distribution of flow rate of the fluid between a top portion and bottom portion of the nozzle at the outlet. In this way, the output stream profile is improved, which can result in greater reach of the fluid from the nozzle.

In one implementation of a flow elbow that configured to improve fluid flow profile in a fire monitor system, an inlet can be disposed proximate a first end of the elbow. In this implementation, the inlet can be configured to receive a flow of a fluid from a manifold of a fire monitor. An outlet can be disposed proximate an open second, where the outlet can be configured to deliver the flow liquid to a nozzle. Further, a hollow body can extend between the first end and the second end and define a throughpassage that is configured to receive the flow of fluid. The body can be curved to redirect the flow of liquid from a first direction to a second direction. A first rib can be disposed in the throughpassage proximate the inlet, and the first rib can extend axially along an interior wall of the body. Additionally, a second rib can be disposed in the throughpassage proximate the outlet, where the second rib extends axially along an interior wall of the body. In this implementation, the first rib and the second rib can form a gap between the first rib and the second rib, and the gap can be configured to allow a portion of the flow of liquid to flow therethrough from a first side of the first rib to a second side of the second rib.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 illustrates an exemplary fire monitor system in which embodiments of the present invention may be utilized.

FIG. 2 illustrates an exemplary flow elbow that may be utilized in a fire monitor device.

FIG. 3 illustrates an exemplary flow elbow that may be utilized in a fire monitor device.

FIG. 4 illustrates an exemplary flow elbow that may be utilized in a fire monitor device.

FIG. 5 illustrates an exemplary flow elbow that may be utilized in a fire monitor device.

FIG. 6 illustrates results from an exemplary flow analysis performed on a fire monitor.

FIG. 7 illustrates results from an exemplary flow analysis performed on a fire monitor.

FIG. 8 illustrates a cross section of an exemplary flow elbow.

FIG. 9 illustrates a cross section of an exemplary flow.

FIG. 10 illustrates a cross section of an exemplary flow elbow having a two piece rib.

FIG. 11 illustrates a cross section of an exemplary flow elbow having a one piece rib.

FIG. 12 illustrates results from an exemplary flow analysis performed on a fire monitor utilizing an exemplary flow elbow with a two piece rib.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

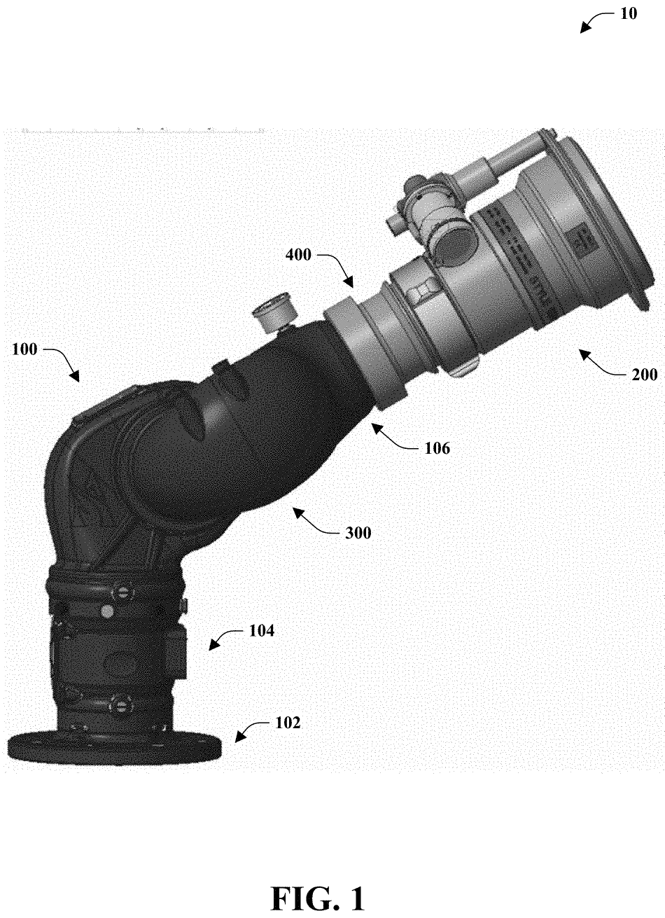

FIG. 1 illustrates an exemplary fire monitor system 10. The system 10 includes a fire monitor 100 and a nozzle 200 operably coupled with the monitor 100 at an outlet end. The fire monitor 100 can include an inlet 102 (e.g., comprising a flange) and a manifold 104. The fire monitor 100 can further include a flow elbow 300 affixed to the manifold 104 and defining an outlet 106. The nozzle 200 can be attached to the monitor 100 at the outlet 106 of the elbow 300. In some embodiments, the system can include a stream shaper 400 installed between the outlet 106 and the nozzle 200.

By way of example, the inlet 102 can be operably, fluidly coupled to a fluid source to supply water (e.g., or other fluids) to the monitor 100. Water (e.g., or other fluids) can be directed (e.g., pumped) into, and can flow through, the monitor 100 beginning at the inlet 102 and flowing through the manifold 104, elbow 300, and into the nozzle 200. The nozzle 200 can direct the flow of fluid in to a fog (wide angle spray) or a direct stream (narrow angle spray). In operation, for example, the overall reach of the stream or fog of fluid may be increased or decreased by increasing the flow or pressure of the fluid at the nozzle 200, and/or by adjusting a shape of the fluid outlet. Additionally, the monitor 100 may be rotated around a vertical axis, and/or pivoted around a horizontal axis to direct the flow of fluid in a desired direction and/or a desired angle of elevation. In this manner, a user can control the direction, elevation, reach, flow, pressure, and stream type, among other aspects. In some implementations, the inlet can comprise a flange (as illustrated) or other type of mechanical coupler, that allows the monitor 100 to be fixedly engaged with a base, anchor, vehicle, or other device to dispose the monitor in a desired location during use.

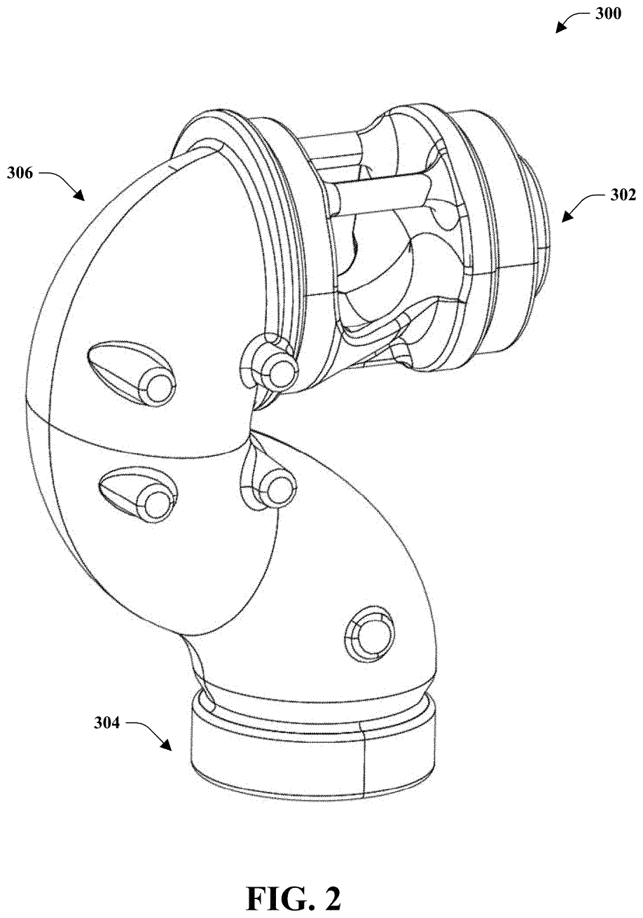

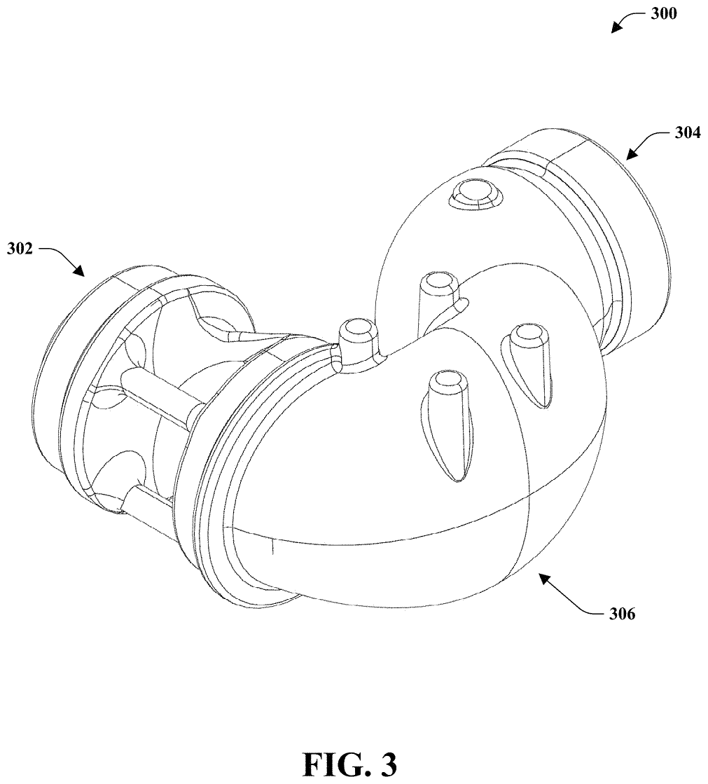

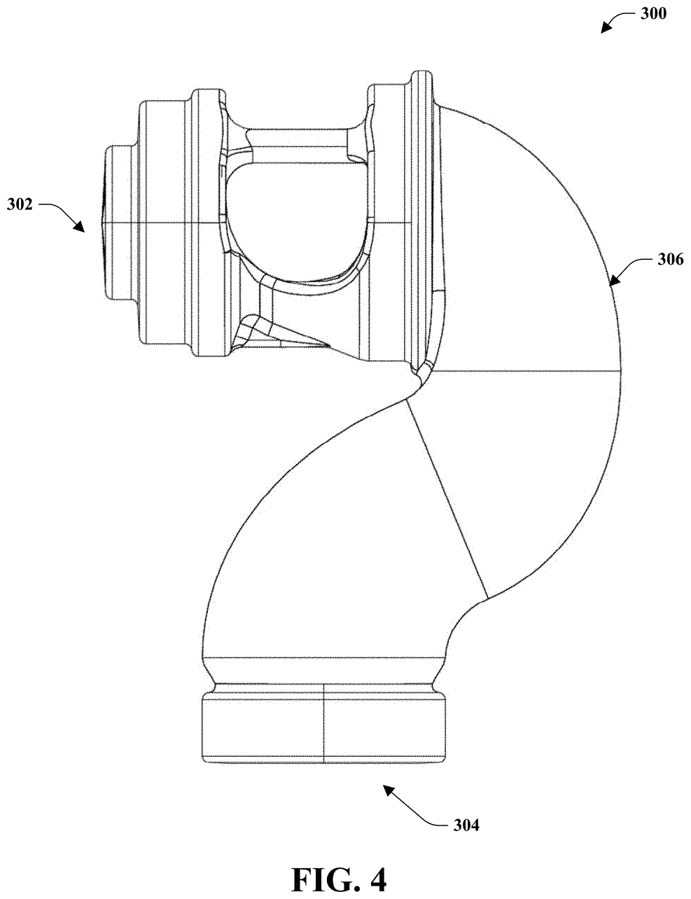

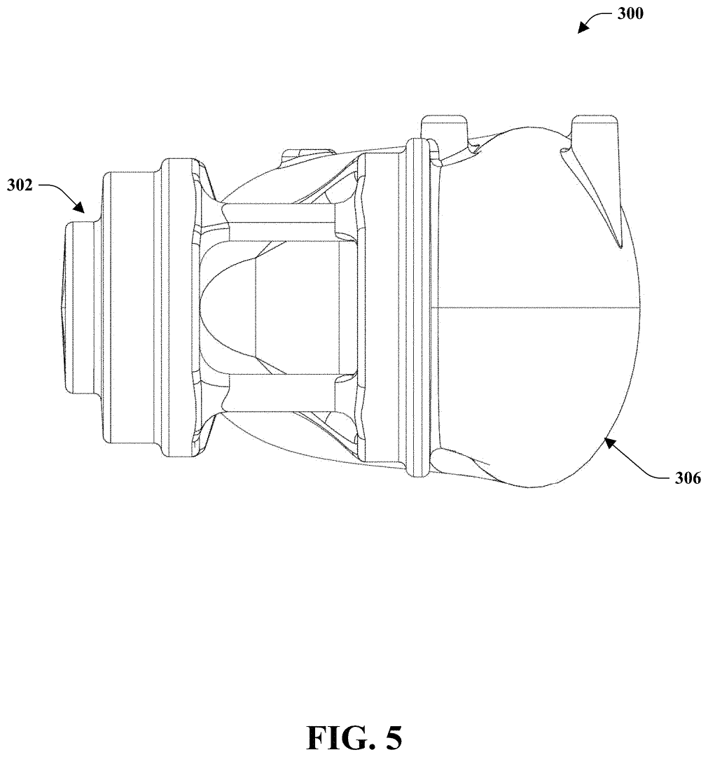

Turning to FIGS. 2-5, an exemplary elbow portion 300 of the monitor is shown. The elbow portion 300 comprises an inlet 302, an outlet 304, and a body 306 defining a flow passage (throughpassage) extending from the inlet 302 to the outlet 304. The body 306 of the elbow 300 can be substantially curved to redirect a flow of fluid from one direction to a second direction. The elbow 300 shown in the figures redirects a flow of fluid from one direction to a second direction where the second direction is rotated approximately ninety degrees from the first direction. It should be appreciated, however, that the elbow 300 can be configured to route the flow of liquid in any suitable direction at any suitable rotation or curve radius according to sound engineering judgment.

Further, for example, the inlet 302 can be operably coupled with an inlet portion (e.g., 104, 102 of FIG. 1) of a monitor (e.g., 100 of FIG. 1). While alternate implementations are anticipated, the example illustrated in FIG. 2-6 show an inlet portion 302 that can be rotated around a horizontal plane to provide adjustments in elevation to an example monitor; where the inlet 302 receives fluid from a base inlet portion. Additionally, in some implementations, the curved shape and angle of redirection of flow of the elbow portion 300 (e.g., and other portions) can be configured to direct a flow of fluid substantially from the outlet 304 (e.g., and out from the nozzle) such that the reactive, opposing force of the flow fluid is directed along an axis that substantially aligns with the base portion, and monitor inlet (e.g., 102, 104). In this way, for example, elevation adjustment can still be provided, while potential torque at the elbow portion 300 and base portion of the monitor is mitigated, thereby reducing strain and wear.

In some instances, it may be desirable to ensure a steady and controlled stream of fluid flows from the nozzle 200 such that the range or reach of the stream is improved (e.g., reaches its potential range). The range of the stream may be affected by a number of factors. For example, a flow rate and/or pressure of fluid flowing through the monitor 100 can be affected by friction from the interior walls of the monitor 100, by impacting a wall at the bends or redirection points, which may also result in turbulence in the fluid flow. All of these things can affect and/or reduce the stream quality and range of the stream at the outlet of the nozzle. For example, friction loss and turbulence result from tight turning angles of the elbow 300. Therefore, it may be desirable to decrease a potential for friction loss and turbulence in the monitor 100 and in the elbow 300, in order to increase the range/reach and stream quality of the fluid exiting the nozzle 200.

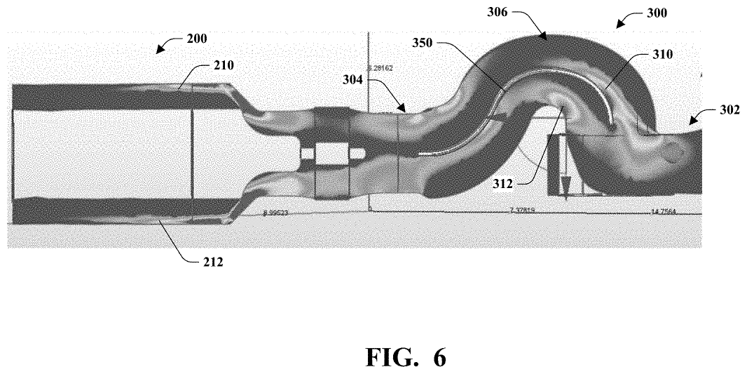

FIG. 6 illustrates results from an exemplary flow analysis of flow rate performed on a fire monitor 100, and specifically on an elbow portion 300 and a nozzle 200 coupled with the monitor 100. The different shading in the figures represents differing flow rates, at different areas, for the fluid flowing through the monitor 100. In color the flow rate increases from dark blue, to light blue, to green, to yellow, to orange, and to red. As illustrated, the flow characteristics for the fluid exiting the nozzle 200 can be indicated by the flow rate in the nozzle; and flow rates at other portions of the monitor can identified to indicate areas that may affect the output flow.

In this example, areas of uneven flow rates are indicated at the elbow inlet 302, the elbow outlet 304, and throughout the body 306 of the elbow 300. As illustrated, the flow rate at the top 310 of the elbow body 306 indicates an increase where the fluid impacts a central rib 350. Further, the flow rate at the bottom 312 of the elbow body 306 also indicates an increase where the fluid impacts a lower wall of the curve of the body 306. The flow rate continues to fluctuate and differ between the top and bottom portions of the elbow portion 300 such that the flow rate leaving the nozzle 200 is different at the top 210 than it is as the bottom 212; noting that the top portion 210 indicates a lower flow rate than that bottom portion 212 along the length of the nozzle outlet. As an example, this may result in an uneven output stream, which can affect reach and shape of the fluid from the nozzle. It should be appreciated that “top” and “bottom” as used herein are for illustrative purposes only.

It may be desirable to mitigate the turbulence and uneven flow rates that are illustrated in FIG. 6. As illustrated, in this example, the elbow 300 comprises a rib 350 running along the approximate center of an interior of the elbow body 306. The rib 350 operably divides the fluid stream into two portion in order to improve uniformity of fluid flow exiting the outlet 304, and to mitigate turbulence within the various portions of the elbow 300. In this example, the rib 350 can be configured to direct the flow of fluid around the bend in the elbow body 306 to reduce turbulence and/or uneven flow rates. The rib 350 extends radially from one end of the rib to the other and extends axially from the inlet 302 to the outlet 304 of the elbow 300. As illustrated, the rib begins upstream prior to the lower curve of the elbow (312), and ends downstream prior to the outlet 304 of the nozzle, while following the curve of the elbow body 306.

In another example, the monitor can include a stream shaper 400 to improve uniformity of fluid flow, and/or to mitigate turbulence within the monitor 100. As indicated by its name, a stream shaper 400 is configured to shape the stream of fluid into a desired shape to improve fluid flow characteristics, such uniformity of flow rates and/or pressures. As an example, a stream shaper may comprise a plurality of uniformly disposed ribs that divide the stream into substantially even portions, where the shaper ribs lie substantially perpendicular to the direction of the flow of fluid.

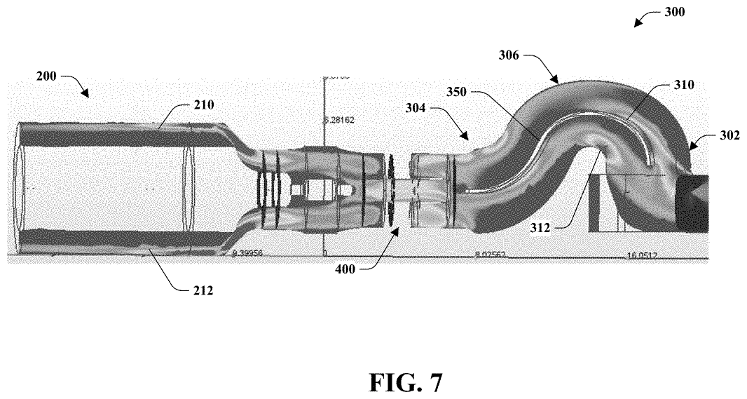

FIG. 7 illustrates a flow analysis that results from performed on a monitor elbow 300 and flow nozzle 200 that comprise one or more stream shapers. In this example, a stream shaper 400 is placed between the elbow 300 and the nozzle 200. The stream shaper 400 is designed to substantially even out the fluid flow characteristics across the flow profile, to help mitigate turbulence in the flow of fluid before the fluid enters the nozzle 200. A more uniform stream profile and a reduction in turbulence provided by the stream shaper 400 may improve the overall stream quality, shape and reach of the stream output. However, it may be desirable to improve flow characteristics in the fire monitor 100 without the use of a stream shaper 400 in certain situations. For example, a target use or design may make it difficult to include a stream shaper 400 into a system 10 due to size restraints, targeted use, and/or limited space. Further, for example, a stream shaper 400 may also create unwanted reduction in flow. Therefore, improving stream profile and/or reach in the output of a fire monitor system 10 without the use of a stream shaper 400 may be beneficial.

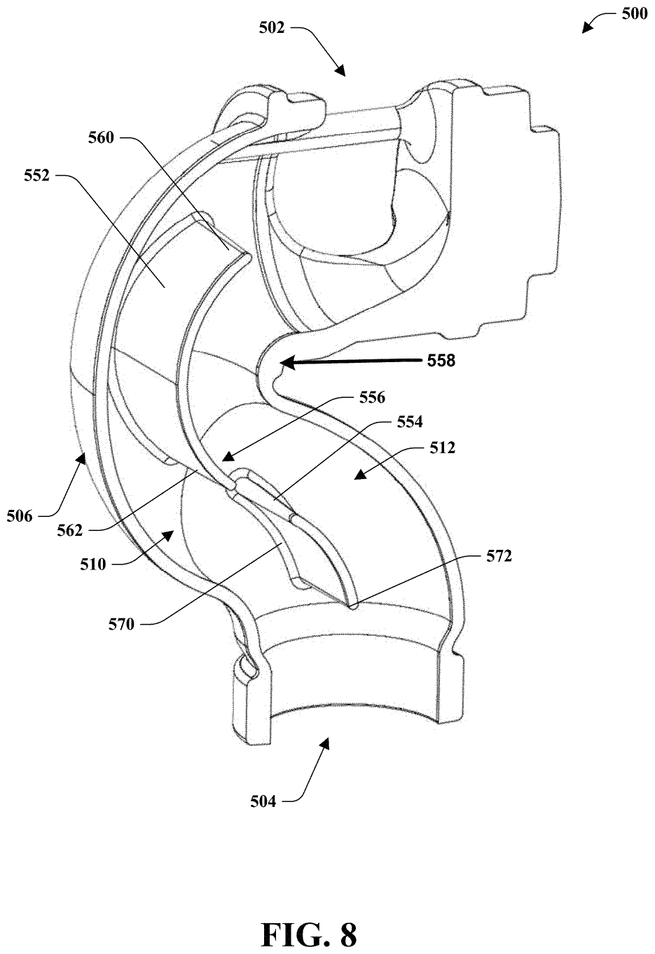

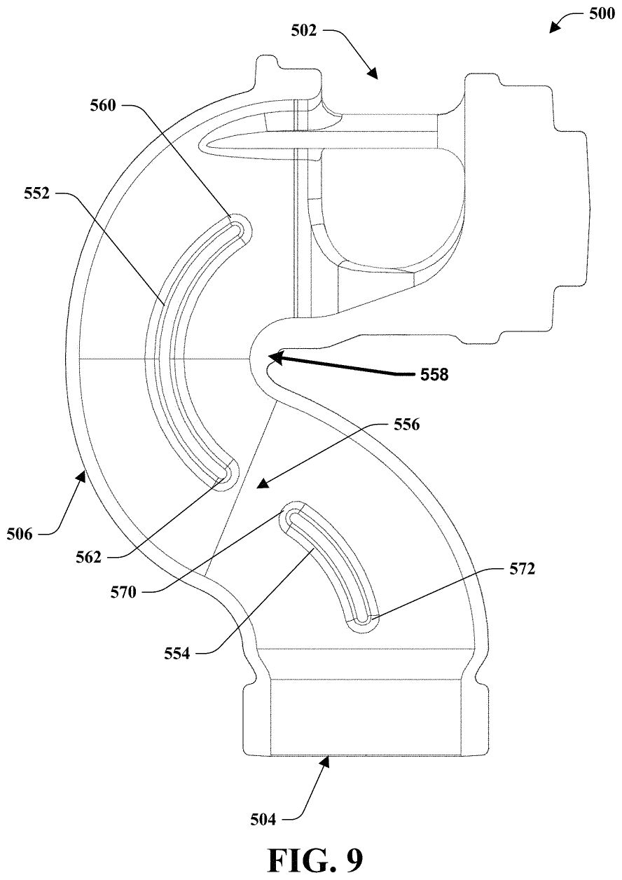

FIGS. 8 and 9 illustrate cross sectional views of an exemplary embodiment of an alternate implementation of an elbow portion 500 of a monitor. In this implementation, the elbow portion 500 can be similar to elbow 300 in most regards, respecting shape, size, curve profile, etc., except as detailed herein. In this embodiment, the elbow 500 can comprise an inlet 502, an outlet 504, and a body 506. The elbow can further comprise a first rib 552, a second rib 554 disposed downstream from the first rib 552, and a gap 556 (e.g., a break) disposed between the first rib 552 and the second rib 554. The first rib 552 and the second rib 554 extend along the interior elbow body 506, operably dividing the fluid stream, from proximate the inlet 502 to proximate the outlet 504 in an axial direction. The first rib 552 and the second rib 554 also extend radially from one end of an interior the elbow to another to divide the stream. In this embodiment, the first rib 552 is located proximate the inlet 502 of the elbow (e.g. upstream) and the second rib 554 is located proximate the outlet 504 of the elbow (e.g., downstream).

In one implementation, a first end 560 of the first rib 552 is disposed upstream prior to the bottom portion 558 of the curved body 506. In this implementation, a second end 562 of the first rib 552 can be disposed at a position downstream from the bottom portion 558 of the curved body 506. Further, in this implementation, a first end 570 of the second rib 554 can be disposed downstream of the second end 562 of the first rib 552, downstream from the gap 556 of a desired length. A second end 572 of the second rib 554 can be disposed before and proximate the outlet 504. The gap 556 between the first rib 552 and the second rib 554 can be configured to allow the flow of fluid to flow from a first side 512 of the elbow to a second side 510 of the elbow. Turbulence may be reduced in the elbow 500 by allowing the flow of fluid to flow through the gap 556.

The size and location of the first and second ribs 552, 554 along with the size and location of the gap 556 can be configured to achieve a desired effect (e.g., improve flow characteristics of the fluid stream) on the flow of fluid through the elbow 500. In the present embodiment, the length of the first rib 552 can be greater than (e.g., approximately twice) the length of the second rib 554. The gap 556 between the first rib 552 and the second rib 554 can comprise a desired length, such as smaller in length than both the first rib 552 and the second rib 554. It should be appreciated that the length and placement of the ribs 552 and 554 and/or the size and placement of the gap 556 can be configured and modified according to sound engineering judgment and flow requirements.

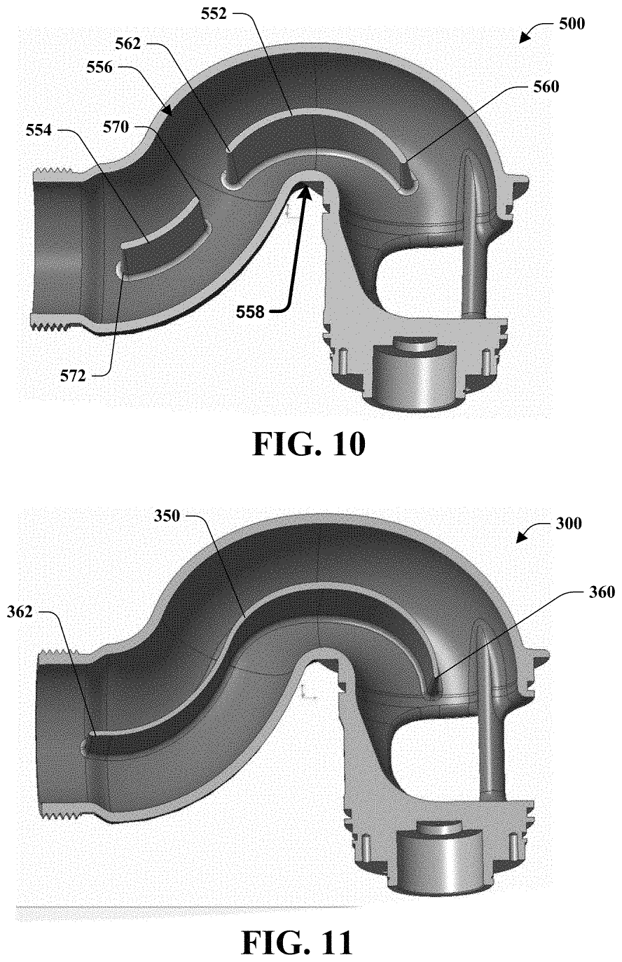

FIGS. 10 and 11 illustrate an exemplary comparison between the elbow 500 and the elbow 300. In this example, the elbow 500 comprises the gap 556 located between the first rib 552 and the second rib 554. Elbow 300 includes a unitary rib 350. In regard to the elbow 500, the first end 560 of the first rib 552 can be located proximate the inlet 502 (upstream) and the second end 562 of the first rib 552 can be located downstream. The first end 570 of the second rib 554 can be located upstream and the second end 572 can be located downstream proximate the outlet 504.

As example, the first end 560 of the first rib 552 of elbow 500 can be located further downstream than the first end 360 of the rib 350 of the elbow 300. Further, the location of the second end 572 of the second rib 554 of the elbow 500 can be located further upstream than the second end 362 of the rib 350. It may be beneficial to use a flow elbow 500 having a first rib 552 and a second rib 554, where a gap 556 is formed between the first rib 552 and the second rib 554 to improve fluid flow characteristics. It may also be beneficial to place the first end 560 further downstream and the second end 572 further upstream. In other words, the combination of rib placement and gap 556 of the elbow 500 may improve outlet fluid flow, and may reduce turbulence in the flow of fluid more effectively than the elbow 300. It should be appreciated that as the angle of the elbow 500 changes (e.g., angle of curvature), so may the configurations of the first rib 552 and the second rib 554. For example, as the curvature of the elbow 500 decreases, the size of the ribs 552 or 554 or the size and location of the gap 556 may be adjusted or modified.

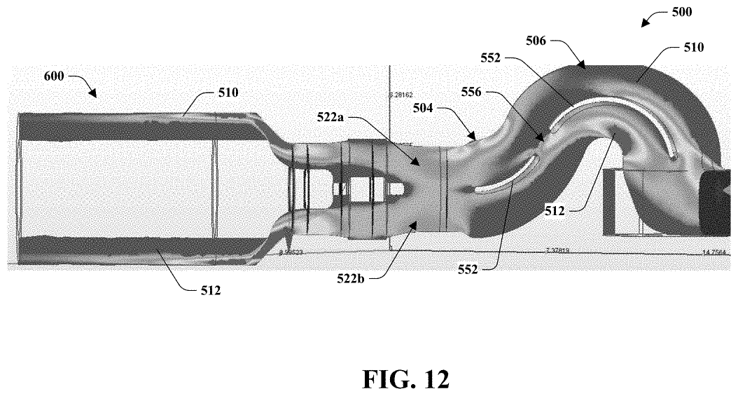

FIG. 12 illustrates flow characteristics that result from an exemplary flow analysis performed on a fire monitor 100, specifically comprising an elbow 500 and a nozzle 200. The flow analysis indicates improved flow characteristics, such as a more even flow between a top and bottom of a fluid flow profile, compared to those indicated in FIG. 6, for example. As illustrated, the flow of fluid may indicate similar fluid flow rate at locations 510 and 512 as with the elbow 300; however, the flow of fluid flows at the gap 556 indicates and increased flow rate. Further, the flow rate at locations 522a, 522b indicate similar (e.g., substantially even) flow, which is an improvement over the uneven flow indicated in the same location for the elbow 300. Further, in FIG. 12, the flow rate in the nozzle 600 is substantially similar at locations 210 and 212, indicating a substantially even flow rate, which is a marked improvement over the uneven flow rate indicated in the elbow 300 at the same locations. It should be appreciated that the improvement in evenness of flow rates, and improved flow profile can help create a more uniform output stream of fluid exiting the flow nozzle 600 compared to a flow monitor system 10 using an elbow with a single piece rib (e.g., rib 300).

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A flow elbow configured to improve fluid flow profile in a fire monitor system comprising:
an open first end and an inlet proximate the first end, the inlet configured to receive a flow of a fluid from a manifold of a fire monitor;
an open second end and an outlet proximate the second end, the outlet configured to deliver the flow liquid to a nozzle;
a hollow body extending between the first end and the second end and defining a throughpassage configured to receive the flow of fluid, wherein the body is curved to redirect the flow of liquid from a first direction to a second direction;
a first rib disposed in the throughpassage proximate the inlet, the first rib extending axially along an interior wall of the body; and
a second rib disposed in the throughpassage proximate the outlet, the second rib extending axially along an interior wall of the body; wherein the first rib and the second rib form a gap between the first rib and the second rib, the gap configured to allow a portion of the flow of liquid to flow therethrough from a first side of the first rib to a second side of the second rib.

2. A fire monitor system, comprising:
a fluid flow nozzle; and
a fire monitor, wherein the fire monitor comprises:
a fluid flow elbow configured to improve fluid stream profile in the fire monitor system, wherein the flow elbow comprises:
an open first end and an inlet proximate the first end, the inlet configured to receive a flow of a fluid from a manifold of the fire monitor;
an open second end and an outlet proximate the second end, the outlet configured to deliver the flow liquid to the fluid flow nozzle;
a hollow body extending between the first end to the second end and defining a throughpassage configured to receive the flow of liquid, wherein the body is curved to redirect the flow of liquid from a first direction to a second direction;
a first rib disposed in the throughpassage proximate the inlet, the first rib extending axially along an interior wall of the body; and
a second rib disposed in the throughpassage proximate the outlet, the second rib extending axially along an interior wall of the body, wherein the first rib and the second rib form a gap between the first rib and the second rib, the gap configured to allow a portion of the flow of liquid to flow therethrough.
